(19) United States
(12) Patent Application Publication
(10) Pub. No.: US 2007/0241491 A1
(43) Pub. Date: Oct. 18, 2007

(54) Device for Supporting Workpieces

(75) Inventor: Andreas Kochberger, Wang (AT)

Correspondence Address: ADAMS EVANS P.A., Suite 2350 Charlotte Plaza, 201 South College Street, CHARLOTTE, NC, 28244, US

(73) Assignee: Renate Kochberger, Wang (AT)

(21) Appl. No.: 11/571,129

(22) PCT Filed: Jun. 21, 2005
(86) PCT No.: PCT/AT05/00218

§ 371 Date: Dec. 21, 2006

(30) Foreign Application Priority Data
Jun. 22, 2004 (AT) A1060/2004

(51) Int. Cl. B23Q 3/10

(52) U.S. Cl. 269/296

(57) ABSTRACT

The invention relates to a device for supporting workpieces, in particular, for multi-side coating of workpieces in a coating press, comprising a press table for housing the device and an adjusting carriage, arranged below the press table, whereby a number of support elements (1), forming the laying surface of the coating press, are provided. Each support element (1) comprises a support sleeve (2), a vertically-displaceable pin (3), housed therein, guide devices (6a, 6b; 7) and fixing devices (5; 8) for the pin (3) and a return element (12), for return of the pin (3) from an upper position into a lower position. The support elements (1) are arranged without a separation.

The invention relates to a device for the support of workpieces in accordance with the preamble to the Main Claim.

The device forming the object of the invention serves to support workpieces which are to be processed on press or cutting tables. During the coating of flat workpieces by means of films in particular, it is necessary for the workpiece to be covered by the film both on the surface and the sides as well as beyond the lateral edges.

To do this, the workpiece is to be supported by an appropriate backing or support, for preference carrier elements, which during the pressing procedure can also be drawn beneath the workpiece to be coated.

### PRIOR ART

Descriptions of such systems are entirely familiar from the literature representing the prior art. In this context, in general, the detection of the covering arrangement and the adjustment of the carriers are linked to form one unit.

In this context, actuating means are used for the height adjustment of the carriers and appropriate locking means for securing the carriers in the desired position.

In this situation, individual actuation and locking means are allocated to each carrier.

For example, a coating press is known for the multi-sided film coating of furniture panels, the laying table of which exhibits grid-shaped passage apertures into which movable carriers, capable of being reversibly altered in their lengths, are inserted. The coating press also makes provision for a device for the recognition of the workpieces lying on it. This device uses a measuring carriage, capable of movement beneath the laying table, with sensors which are capable of detecting the impinging light coming from above through the passage apertures. In this situation, each carrier is surrounded by four sensors. If none of the sensors surrounding a carrier register an impingement of light, this provides assurance that this carrier is completely covered by the workpiece. Depending on the coverage, the carriers, moved out into their basic setting, are then shortened or remain in their basic setting.

The carriers inserted into the passage apertures of the grid frame so as to be capable of movement are lengthened by means of a groove provided for in the lower part of the carrier.

Systems are also known with which all the actuating means can be brought into operation by means of a common lifting device. In this situation, the carriers are arranged in lines and rows which can be subjected to actuation by the actuation means

Common to the known systems is their generally complicated and elaborate structure. Reliability in use is therefore called into question.

### EMBODIMENT OF THE INVENTION

The object of the invention is therefore to provide a device for the support of workpieces which allow for the raising, lowering, and locking of the carriers in a simple manner, and therefore reduces the operational effort and expenditure.

The invention resolves the problem in that each carrier element forms an independent and replaceable unit, and is arranged without an interval gap between it and the adjacent carrier elements, that the pin is cylindrical in shape and comprises two guide elements located opposite one another, that the carrier sleeve comprises two guide slots on its inner side to accommodate the guide elements, that each guide slot exhibits in its upper end area a groove for fixing the guide elements, and that inside the carrier element provision is made for a resetting element for guiding the pin back out of an upper position into a lower position.

A large number of carrier elements arranged in a row next to one another therefore form a laying surface. In their basic position the pins are raised up. The workpieces can be laid down on them with no problem at all. The location and shape of the workpieces are detected by means of a scanner and forwarded by a computer to a control element. Pins located in the peripheral areas of workpieces are lowered in order to allow for problem-free film application.

Thanks to a block-type structural design of the carriers, the entire carrier element can be removed in the event of damage to one of the constituent parts and replaced by a new one. This does not require any special tools or specially trained fitters.

According to a further feature of the invention, the carrier elements are arranged on a base plate of the press table of the coating press or on an open grid formed from flat elements, for preference flat iron elements. In particular, the arrangement on an open grid on the one hand reduces the manufacturing costs, and, on the other, also allows for the use of narrow pins. This results in a higher “resolution”, and it is also possible, for example, for a bar frame to be pressed into position.

A further feature of the invention is that the guide elements are elements which project forwards out of the cylinder, and that the pin exhibits in its lower area a thickening so as to guide the pin in the carrier sleeve.

As already indicated, provision is also made for the carrier sleeve to comprise on its inner side two guide slots to accommodate the guide elements, and that each guide slot exhibits a notch in its upper end area for fixing the guide elements.

The raising and lowering of the pins is therefore effected by way of a connection between the pin and the carrier sleeve. The pin does not need to be extended in order to reach its upper position, but rotates and is securely guided upwards.

According to another feature of the invention, the carrier sleeve exhibits in the area of its passage aperture for the pin an upper edge, and the upper edge of the carrier sleeve is of smaller diameter than the section accommodating the thickening of the pin. The pin is therefore also guided securely in this area. In order for the pin to be pressed into the notch at the moment of its greatest stroke downwards, and therefore to be fixed, according to the invention provision is made in the area between the upper side of the thickening and the inner side of the upper edge for a spring (5), capable of vertical movement inside this area.

To reset the pin, i.e. to lower it, a resetting element is provided for. According to a further feature of the invention, the resetting element is a pin-shaped element guided in the casing of the carrier sleeve. The resetting element comprises in its upper section an activation area for the guide elements, said activation area connecting to the notch in the basic setting of the resetting element. In the non-activated state, the resetting element is therefore in contact with the activation area of the individual guide element.

The activation area can be designed as roof-shaped or conical, in order that it can interact better with the guide elements depending on their design, namely cylindrical or spherical.

According to further features of the invention, the guide elements are arranged in the area of the thickening, or the guide elements are designed so as to terminate with the base surface of the thickening.

Another feature of the invention is that the resetting element comprises a spring positioned in a cut-out or aperture in the carrier sleeve, that the resetting element exhibits a ring, that the spring is arranged between the upper side of the cut-out or aperture and the upper side of the ring of the resetting element, and that, in the basic position of the resetting element, the ring lies in contact on the base plate or the frame.

The resetting element is therefore guided in a cut-out in the carrier sleeve, and is moved against the spring pressure upwards in order to lift the guide elements out of the notch, and to position the pin downwards. The pin is simultaneously raised by the vertical movement of the resetting element and pressed a little to the side. As a result, it slides easily out of the notch and downwards via the guide slot. The spring positioned in the upper area of the carrier sleeve and the weight of the pin support the downwards movement of the pin, held in the notch by the spring pressure.

According to another feature of the invention, the guide slot runs in the carrier sleeve in a spiral shape. Depending on the design of the device, the rise of the guide slot may vary.

According to a further feature of the invention, provision is made for the pin to exhibit an elastic support surface extending over its cover surface, and for the cover to be coated in an anti-adherence manner, for preference with teflon.

The carrier element is designed in this situation in block design with, for preference, a square cross-section, and is connected to the base plate or the frame by means of screws or a clip connection. The connection is effected in the corner areas of the carrier element. The removal or replacement of a carrier element can therefore be carried out entirely free of any problems.

According to a further feature of the invention, the resetting element is guided further downwards through the base plate or the frame, in order to interact with an activating device.

This activating device for activating the resetting elements is located, according to the invention, together with a setting device to set the pin into its upper position, on a setting carrier arranged beneath the pressing table.

According to a further feature of the invention, provision is made for the setting device to be designed in the shape of an elevation, and that a setting device is allocated to each row of carrier elements running in the intake direction into the press area.

Setting carrier and press table move against one another. In this situation, all the pins are raised upwards by means of the setting device. The workpieces can be laid on the table.

To lower the pins detected by the scanner, the corresponding resetting elements are moved upwards by the actuating device and the pins are lowered.

A further feature of the invention is that a corresponding activator of the activation device (19) is provided for each row of carrier elements.

According to the invention, the activator can be cylindrical shaped, and comprise a piston capable of moving vertically in this cylinder for the activation of the resetting element.

In order to guarantee a more rapid activation, according to the invention the piston carries a rotatably mounted roller or disk. As a result of this, the activation can be effected earlier, since the roller or disk finds its way more easily to the underside of the resetting element than the piston alone, which must coincide precisely with the cut-out in the base plate or the frame which is penetrated by the resetting element, in order to be able to initiate activation.

According to the invention, the piston can be activated electromagnetically, pneumatically, or mechanically.

In order to enlarge the contact surface and to secure the contact of the workpiece, according to another feature of the invention the pin is provided with a cap, whereby the pin and the cap are connected by means of a connection element, which is detached so as to prevent twisting.

This is important in order to avoid twisting of the cap when the pin is lowered.

Twisting of the pin could lead, for example, to a displacement of the workpiece.

Another feature of the invention is that the cap exhibits on its surface a slip-resistant, elastic element, with anti-adherence coating, that the cap is designed to be roof-shaped in its side areas, broadening towards the base, and that the side areas of the cap widen as far as the side length of the carrier element.

The invention is now described in greater detail on the basis of an embodiment, with the aid of the appended drawings.

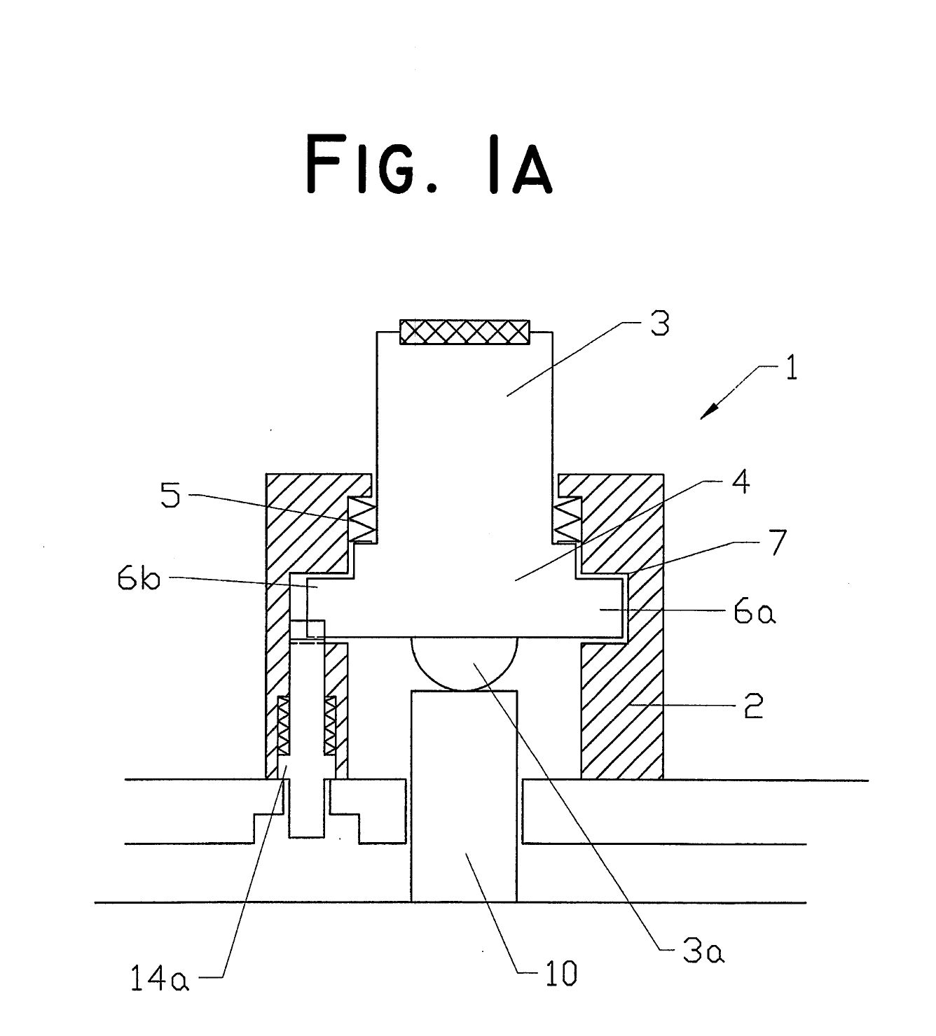

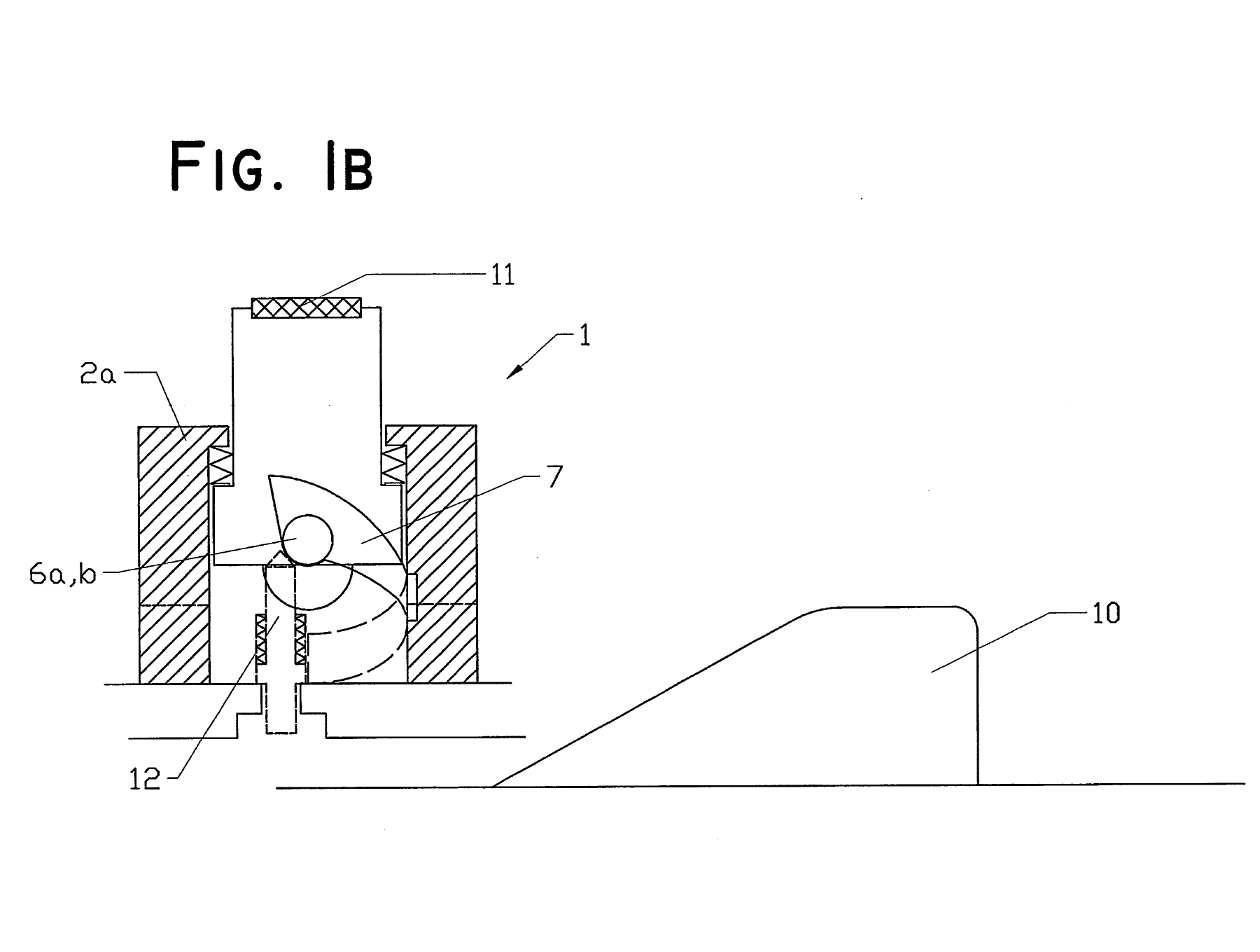

FIGS. 1a, b, show the carrier element according to the invention,

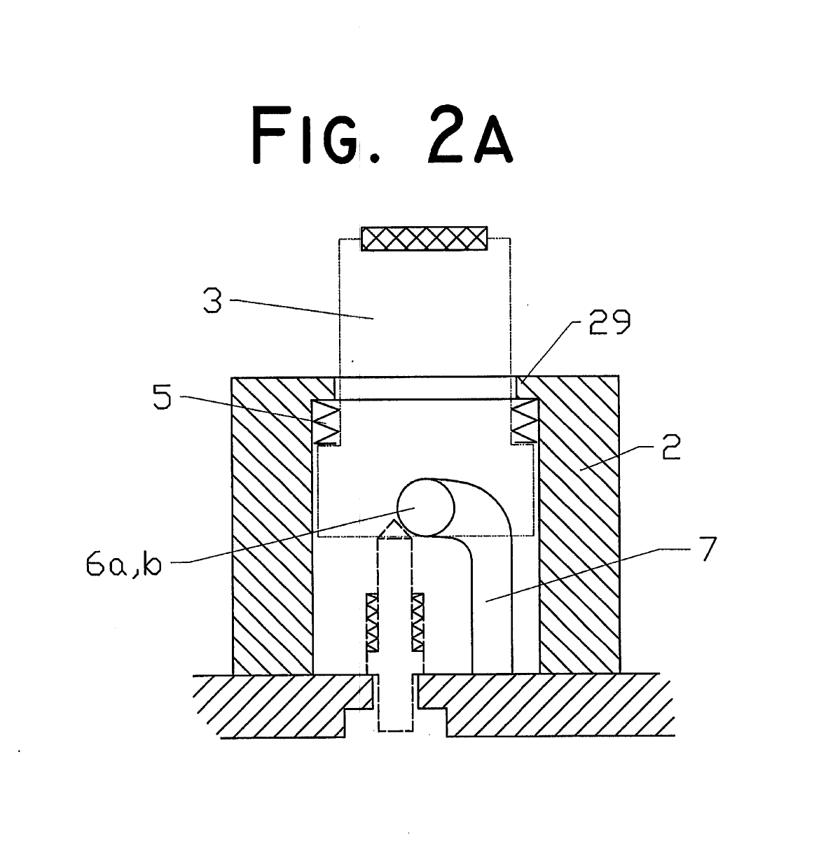

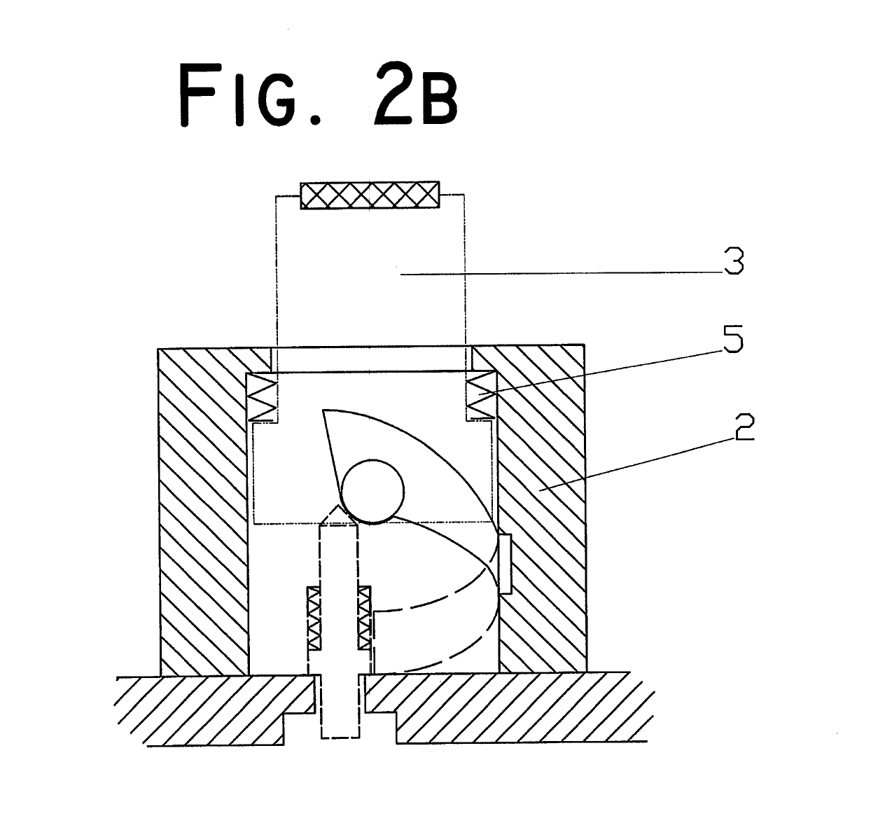

FIGS. 2a, b, the carrier element according to the invention in a different embodiment,

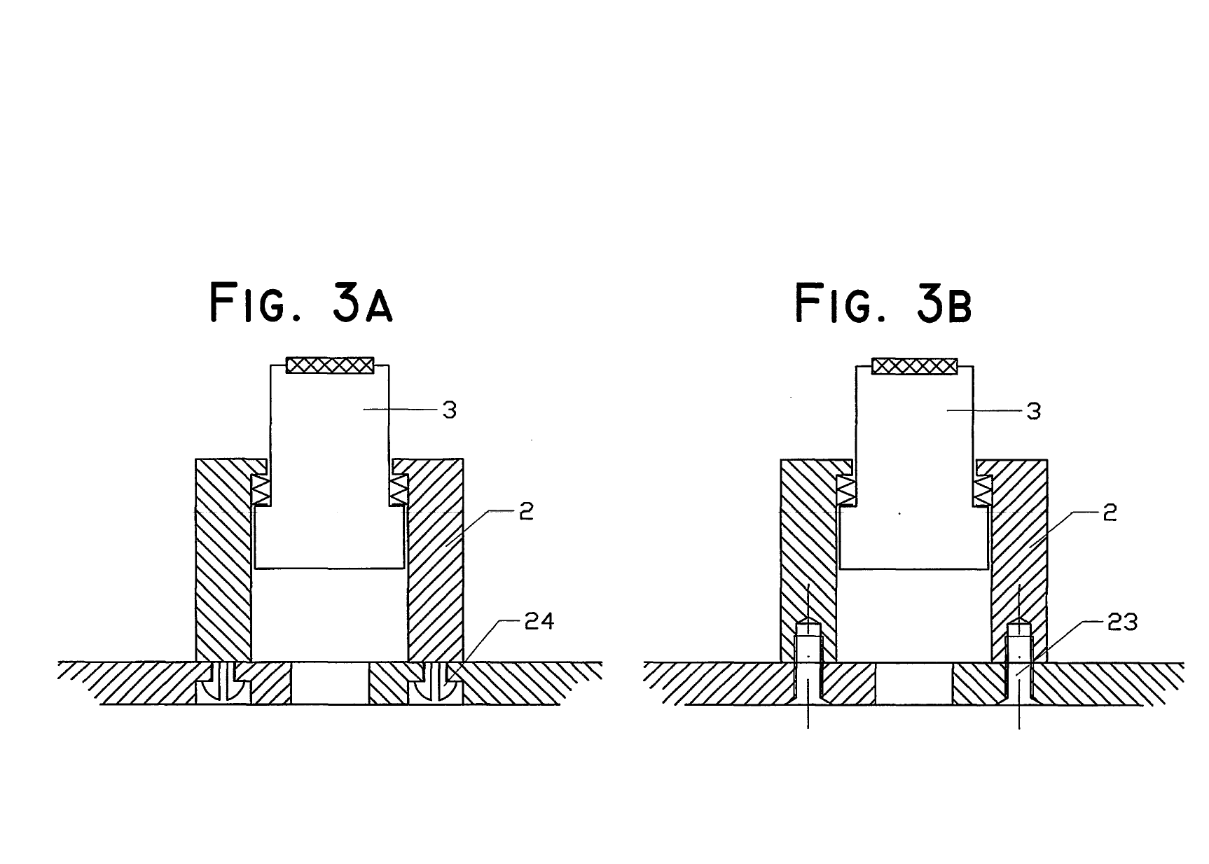

FIG. 3a, b, securing variants of the carrier element according to the invention,

FIG. 4 a detailed representation of the locking arrangement of the pin,

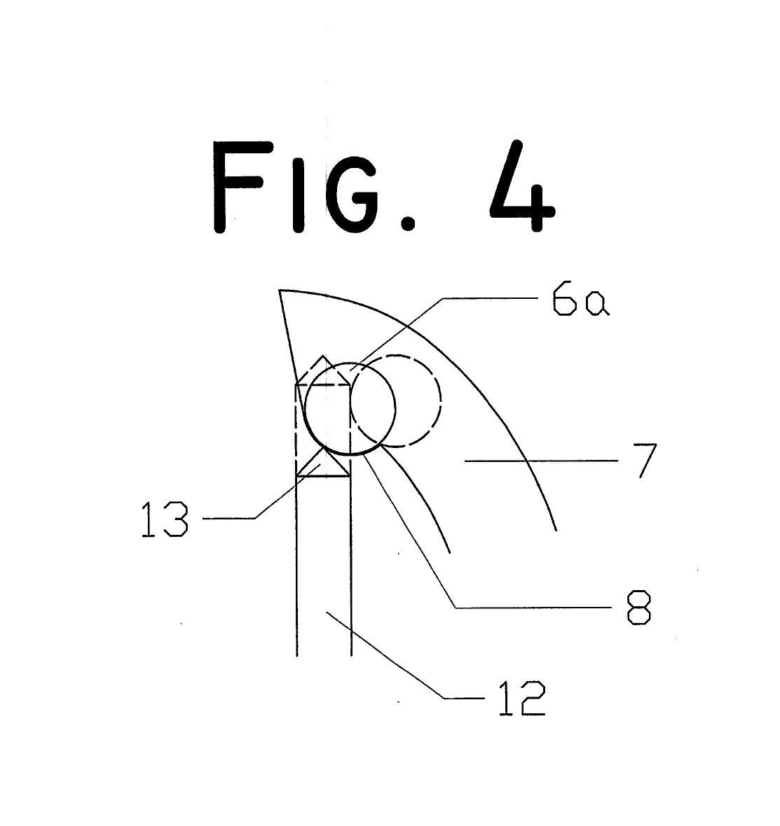

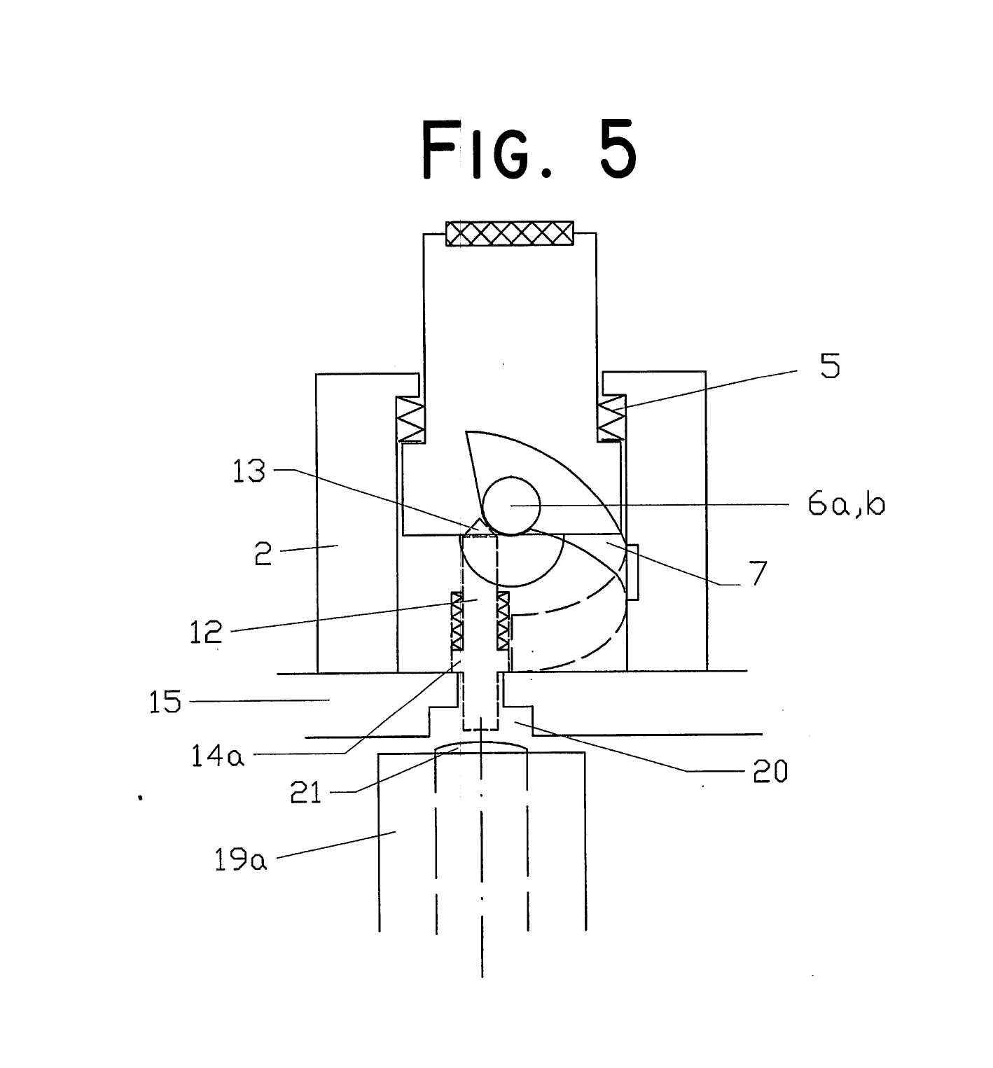

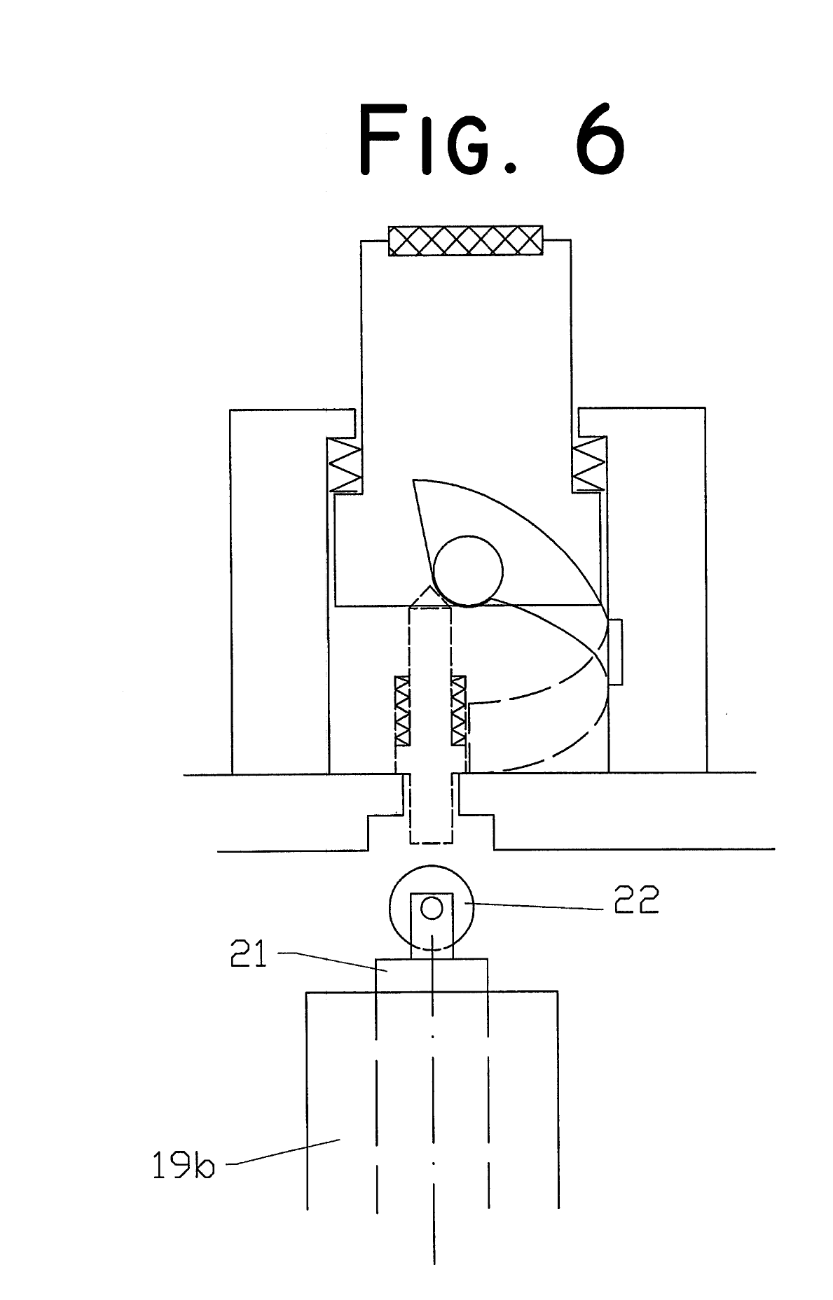

FIGS. 5, 6, variants of the unlocking arrangement of the pin,

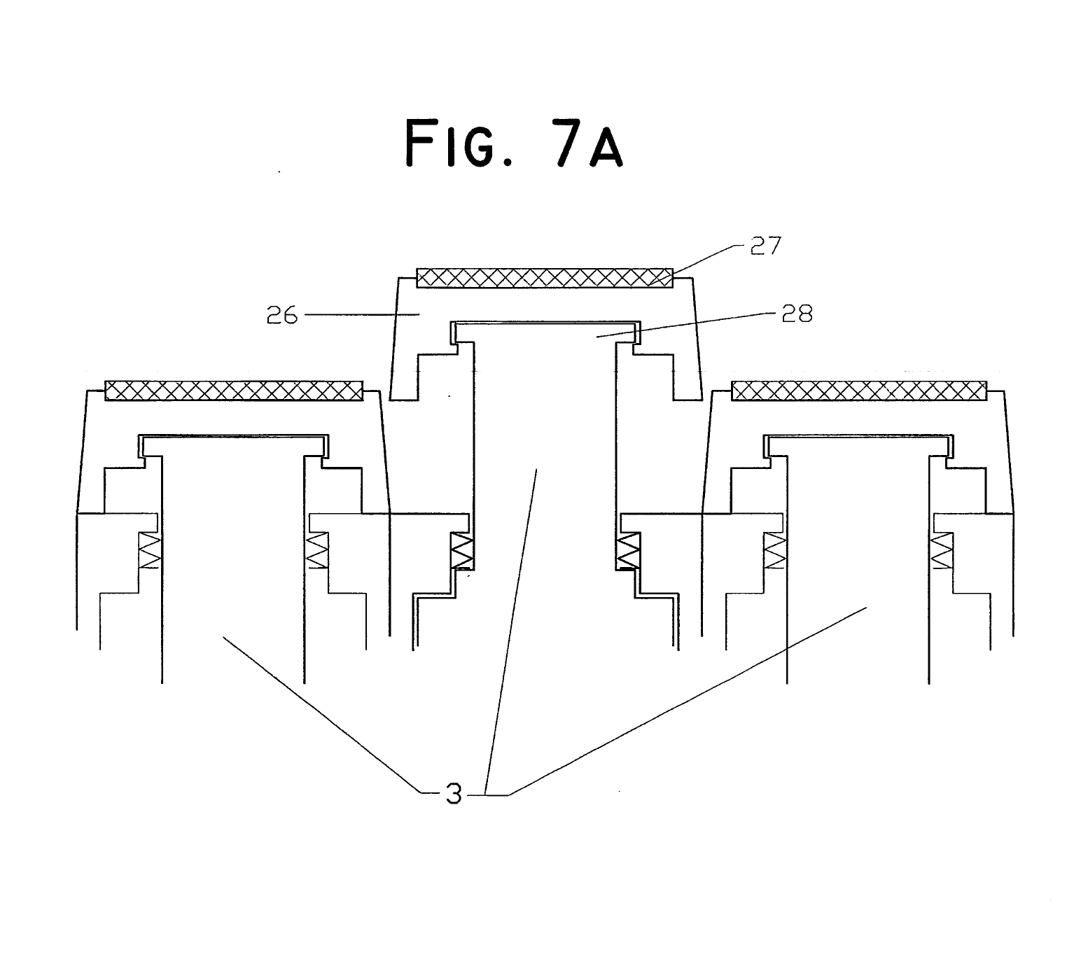

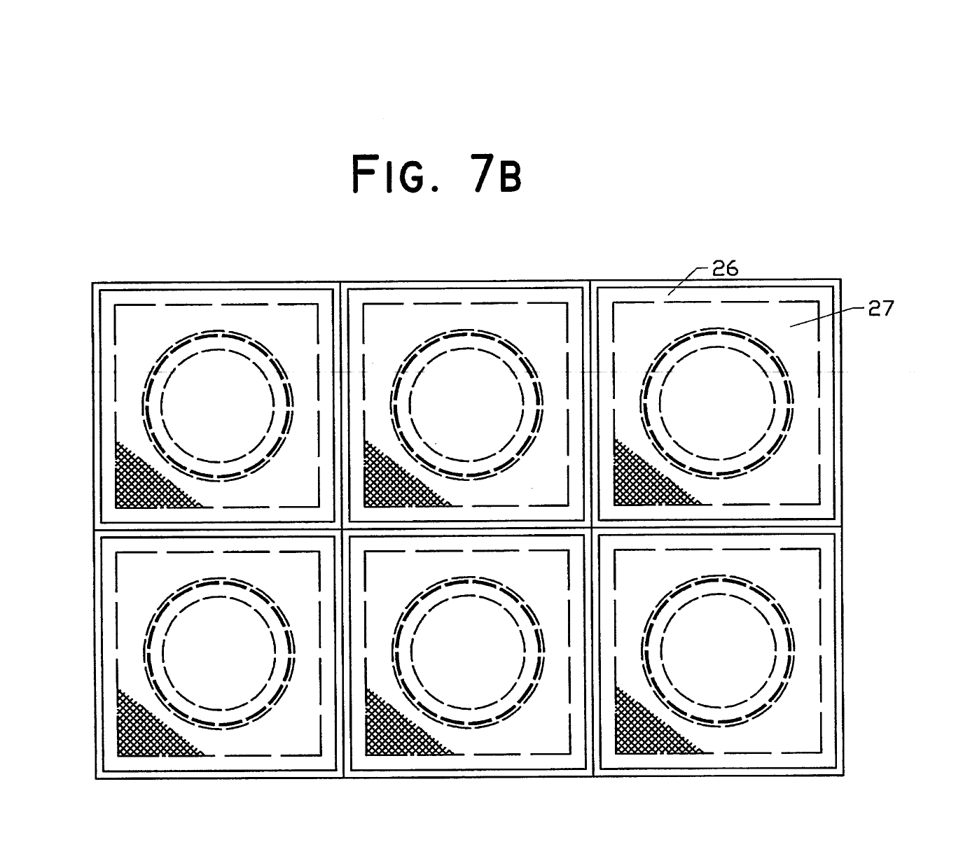

FIGS. 7a, b, carrier elements with the cap in place, as a sectional and plan view,

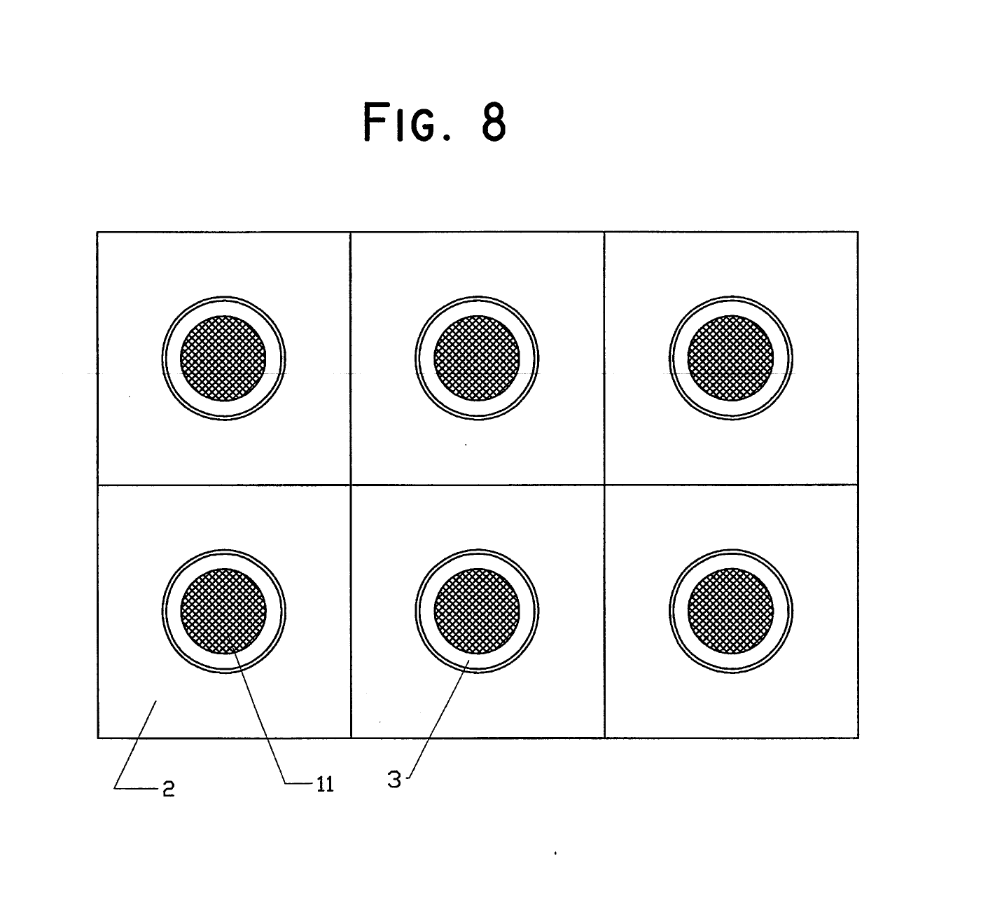

FIG. 8 a plan view of carrier elements without caps,

FIG. 9 a section through a carrier element inserted in a frame,

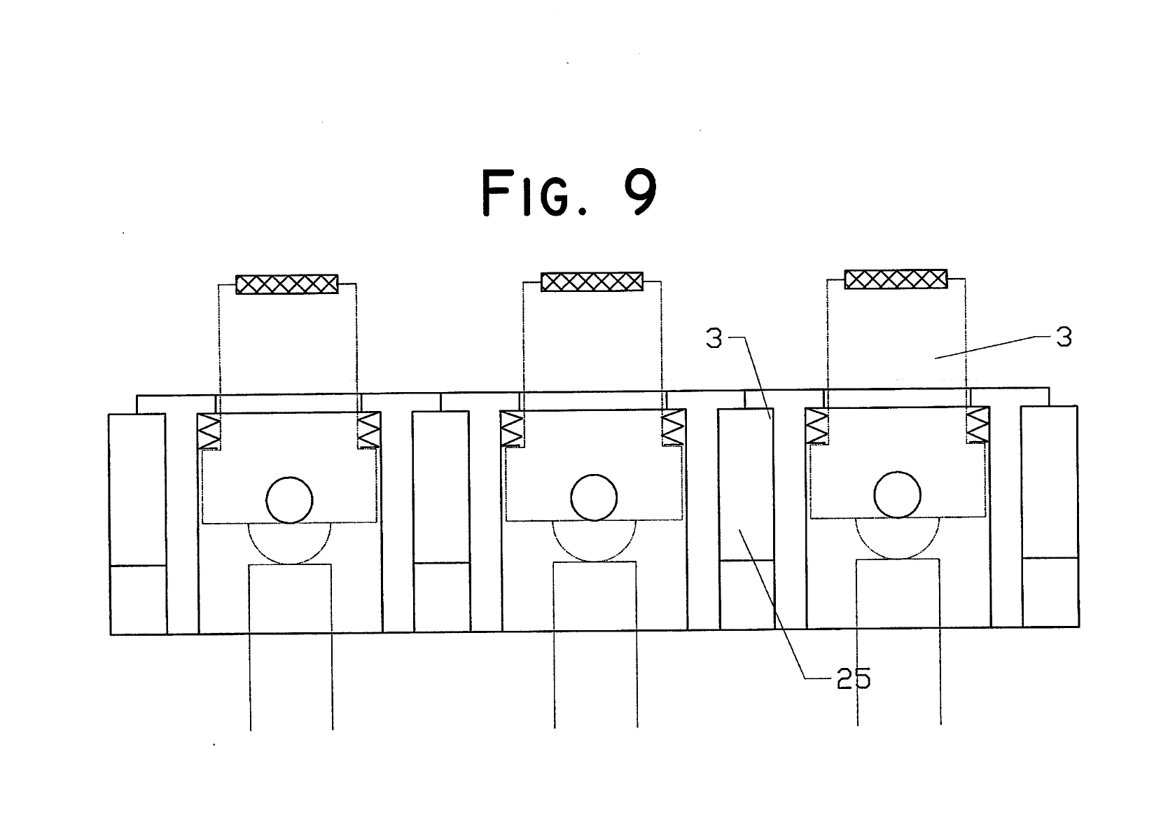

FIG. 10 a plan view of carrier elements inserted into a frame,

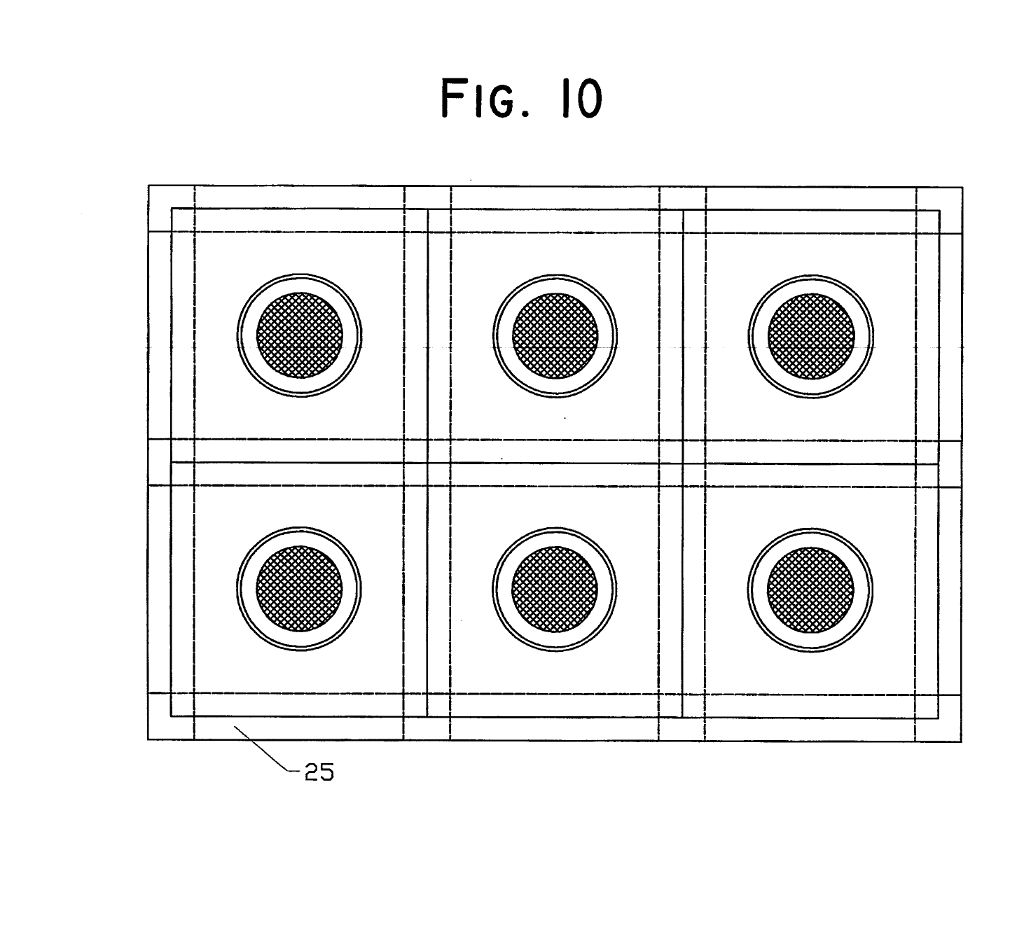

FIG. 11 a plan view of a section of a press table with allocated carrier elements, and

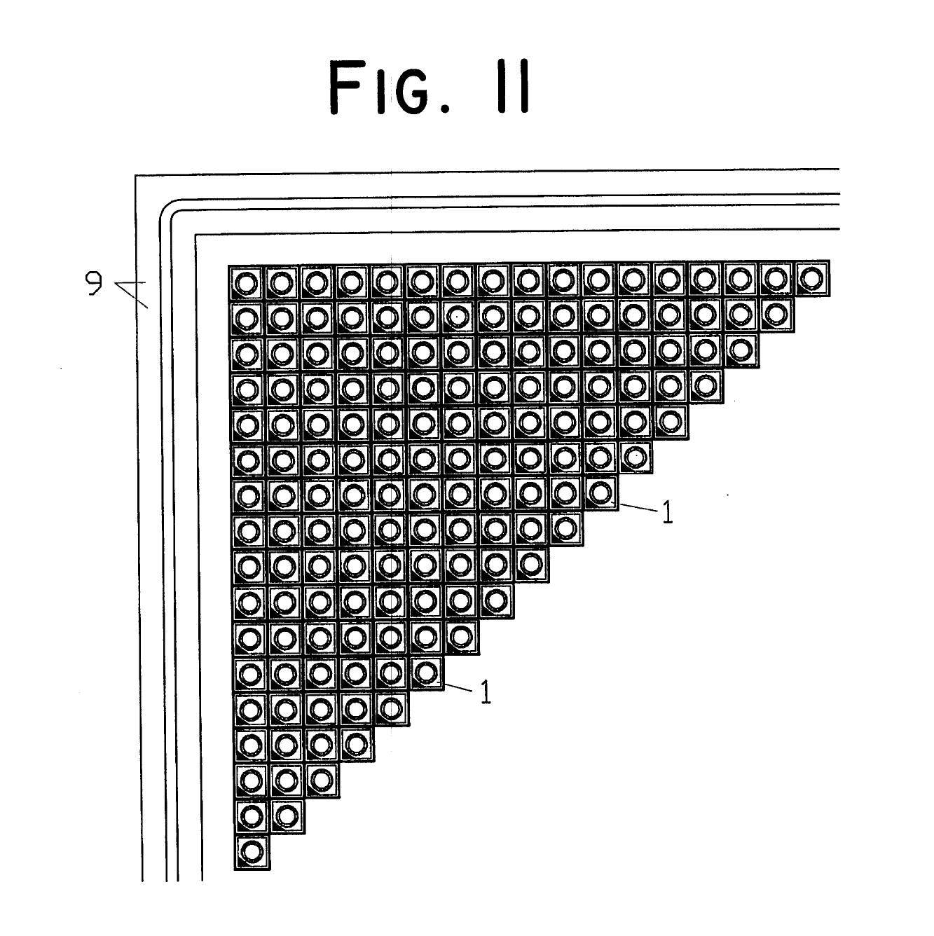

FIG. 12 a diagrammatic representation of a press unit, in a plan view.

The embodiment forming the object of the invention shows the use of the device in a coating press.

The carrier elements 1 represented in FIGS. 1a, b, are provided in order to position the workpieces to be coated.

Each carrier element 1 comprises a carrier sleeve 2 and a pin 3 which can be inserted into this and can be moved vertically. Each pin 3 exhibits a thickening 4 in its lower area. This forms a plane, which carries a spring 5. In its upper, extended position, the spring 5 is under tension between the thickening 4 and the upper edge 2a of the carrier sleeve 2, and is held in position by these two edges.

Likewise in its lower area, and projecting from the thickening 4, the pin 3 exhibits two mutually opposed guide elements 6a, b. These are for preference designed as cylindrical shaped, but can also be designed as spheres or in any desired form suitable for the performance of the task described hereinafter.

The guide elements 6a, b, forming the object of the invention engage in two guide slots 7 [the representations show in each case only one of the slots] provided in the carrier sleeve 2.

The reliable raising and lowering of the pin 3 in the guide sleeve 2 is therefore guaranteed. In order to fix the pin 3 in its upper position, each of the guide sots 7 are provided in their upper area with a notch 8. The guide elements 6a, b engaged into these. This engagement is guaranteed in particular by the pressure from the spring 5. This presses the raised pin 3 out of its highest position a little way downwards at the moment at which the raising force is reduced. The pin 3 is fixed in the notch 8 as a result.

In the basic position each pin 3 is in its upper position. The pins 3 arranged on the press table 9 in close formation, see FIG. 11, are raised upwards by means of a setting device 10. In the representation according to FIG. 1b this is designed as an element in an elevation shape. Allocated to each row of carrier elements 1 running in the intake direction into the press area is a setting device 10. As a result of a relative movement of the press table 9 in relation to the setting devices 10, the pins 3 are necessarily guided upwards via the guide slot 7, and then, due to the spring force of the spring 5 as well as due to their own dead weight, they are then held in position in the notch 8. In addition to this, the spring 5 also takes effect against a tilting of the pin 3 and guarantees a secure fixing of the guide elements 6a, b, in the notch allocated to them in each case, both when the press table 9 is occupied as well as when it is moved into the pressing chamber. In order for the guide slot 7 arranged in screw fashion in the carrier sleeve 12 to move outwards with the appropriate flat rise, and therefore over a long path, the pin 3 is conducted onwards beneath the thickening 4 as a spherical element 3a. The elevation 10 engages in this and raises the pin 3 upwards. In this situation the spherical element 3a corresponds in its height to the raising stroke.

The raising of the pin 3 can also be effected by means of a rod or pneumatically. These embodiments are not represented. Ideally, the setting device 10 engages on the underside of the pin not only in “linear form” but over as large an area as possible. As a result, on the one hand a continuous transfer of force is guaranteed, and, on the other, less wear.

In the lying contact area of each pin 3, provision is further made for an elastic support 11 to treat the underside of the workpiece gently. The elastic support 11 is in any event coated so as to be anti-adherent, for example with teflon.

When being raised, each pin undergoes a screwing movement. The circumference of the rotation depends on the design of the guide slot 7.

FIG. 2a shows a guide slot 7 with a “steep” rise, and FIG. 2b a guide slot 7 with a “flat” rise.

Each carrier element further comprises a resetting element 12, in order to raise the guide elements 6a, b, out of the notch 8 and to bring the pin 3 into its lower position.

The resetting element in question 12 comprises an activation area 13, designed for preference as roof shaped or conical. With this the resetting element 12 engages with the guide element 6a and raises it against the pressure of the spring 5 sufficiently far out of the notch 8 that the pin 3 as a consequence of its own weight slides downwards over the guide slot 7. The resetting element 12 is arranged so as to be movable in a cut-out in the guide sleeve 2. Its movement is guided by a spring 14; this spring 14 also limits the lift of the resetting element 12, since a movement is only possible inside the spring area. Downwards, the position of the resetting element 12 is secured inside the carrier sleeve 2a by a ring 14a. This ring 14a lies, as represented in FIG. 5, on the base plate 15, made for preference of aluminium, of the press table 9. The resetting element 12 is pressed by the spring 14 against the base plate 15.

In order to activate the resetting element 12 from beneath the press table 9, and in order to activate the pin 3, the resetting element 12 is guided beneath the ring 14a outwards through the base plate 15.

FIG. 4 shows the unlocking of a guide element 6a. The representation without hatching represents the locked position, and the hatched representation represents the unlocked position.

In order to raise the guide element 6a out of the locked position, the resetting element 12 is moved upwards until the guide element 6a is raised out of the notch 8, but at the same time is also pressed accordingly to the side, in order, as a consequence of the spring force of the spring 5 and its own weight, for it to slide downwards along the guide slot 7.

If, despite this, the pin 3 should “wedge” a little, it will nevertheless be drawn downwards in any event in the press area by the underpressure prevailing in that area.

In their basic position, all the pins 3 of the carrier elements 1 are in the upper position. The press table 9, as represented in FIG. 12, is located outside the pressing area 16. It is loaded with workpieces of any desired type and size, not shown. The size and position of the workpieces are determined by means of a scanner 17, represented in diagrammatic form. The occupation arrangement detected by the scanner 17 undergoes further processing in a unit, not shown, whereby the pins 13 which are to be lowered are determined. The relevant data is transferred via a control device to a positioning carriage 18 provided beneath the press table 9, which carries at least one activation device 19 for the resetting elements 12. This activation device 19 comprises in this situation activation devices 19a, b, for the individual resetting elements 12, corresponding to each row of carrier elements 1 provided for in the direction of movement of the press table 9.

The activation device 19 is arranged transverse to the direction of movement of the press table 9. During the relative movement of the press table 9 to the activation device 19, the corresponding pins 3 are activated line by line.

The activators 19a, b, are activated for preference by means of appropriately allocated electromagnetic elements.

FIG. 5 shows an activator 19a designed in cylindrical shape, which comprises a piston 21 capable of vertical movement, which carries out the activation process. This embodiment requires a “precise” activation, i.e. exact in time and place, in order for the resetting element 12 to be contacted by the piston 21 precisely inside the cut-out 20 of the base plate 15. To simplify this, the cylinder-shaped activator 19a is provided with a central cap 21.

FIG. 6b shows an embodiment 19b of the activator, whereby a rotatably mounted roller or disk is located on the piston. Thanks to this arrangement, the process can be run through more rapidly if required. Thanks to the rotatably mounted roller or disk 22, the activator 19b can already be activated when the gap of the carrier elements 1 to be served, and therefore the corresponding pins 3, have not yet directly arrived in the activation area. The roller or disk 22 then finds its way to the underside of the resetting element 12. The activation of the pins 3 takes place more fluidly.

FIGS. 3a, b, show variants of the securing of the carrier element 1 to the base plate 15. The carrier elements 1, designed as square in block shape, are likewise secured to the base plate 15 in the corner areas, depending on the embodiment, with screws 23 or clips 24.

The carrier elements 1 are provided as easily replaceable elements thanks to their design and the manner in which they are secured. In the event of damage to an element, it can therefore be replaced easily and cheaply, instead of needing to dismantle a complicated system or even the entire plate in which the carrier elements are integrated.

Instead of the base plate 15, which must exhibit a certain thickness in order to have stability, a grid 25 can be used, made for preference of flat iron elements. The carrier elements 1 are for preference “clipped” into this grid, or also screwed to it. The carrier elements 1 in this situation extend partially downwards through the grid 25. FIG. 9 represents a section through an arrangement of carrier elements 1 inside a grid 25. A corresponding plan view of such an arrangement is shown in FIG. 10.

In general, the pins have a diameter of between 25-30 mm. In order to obtain a higher resolution and therefore to obtain a finer structure of the workpieces, such as bar frames, the diameter of the pins 3 can be reduced down to 15 mm.

In order to counteract a “twisting” of the workpiece due to the slight rotation of the pin 3 when lowering, in the embodiment represented in FIG. 7a, b, they are provided with a square cap 26. The cap can, as shown in FIG. 7a, be angled in roof fashion on its sides.

The surface of the cap 26 is provided with a slip-resistant elastic element 27. The pin 3 is connected to the cap 26 by means of a connection element 28, which holds the cap 26 in a stable condition even when the pins 3 are moving; i.e. the two parts are decoupled and rotation of the cap 26 is avoided.

A plan view of this arrangement is shown in FIG. 7b.

A plan view of the pins 3 without a cap 26 is shown in FIG. 8.

1. A device for the support of workpieces, especially in the case of multi-sided coating of workpieces in a coating press, with a press table for accommodating the device, carrier elements forming a lying surface of the coating press, in each case with a pin capable of moving in a carrier sleeve between an upper and lower position, as well as a positioning carriage arranged beneath the press table, characterised in that each carrier element forms an individual and replaceable unit, and is arranged without a distance interval to the adjacent carrier elements, that the pin is cylindrically shaped and comprises two mutually opposed guide elements, that the carrier sleeve comprises on its inside two guide slots to accommodate the guide elements, that each guide slot exhibits a notch in its upper end area to fix the guide elements, and that inside the carrier element a resetting element is provided for returning the pin out of an upper position into a lower position.

2. The device according to claim 1, characterised in that the carrier elements are arranged on a base plate of the press table of the coating press.

3. The device according to claim 1, characterised in that the carrier elements are arranged on an open grid made of flat elements, for preference flat irons.

4. The device according to claim 1, characterised in that the guide elements are elements projecting from the cylinder, and that the pin exhibits in its lower area a thickening to guide the pin in the carrier sleeve.

5. The device according to claim 4, characterised in that the carrier sleeve exhibits an upper edge in the area of its passage aperture for the pin, and that the upper edge is of smaller diameter than the thickening of the section of the carrier sleeve which accommodates the pin.

6. The device according to claim 4, characterised in that a spring is provided in the area between the upper side of the thickening and the inner side of the upper edge, this spring being vertically movable in this area.

7. The device according to claim 4, characterised in that the resetting element is a rod-shaped element guided in the casing of the carrier sleeve, and that the resetting element comprises in its upper section an activation area for the guide elements, said activation area connecting to the notch in the basic position of the resetting element.

8. The device according to claim 4, characterised in that the resetting element is comprised of a spring positioned in a cut-out or aperture in the carrier sleeve, that the resetting element exhibits a ring that the spring is arranged between the upper side of the cut-out and the upper side of the ring of the resetting element, and that the ring, in the basic position of the resetting element lies on the base plate or the grid.

9. The device according to claim 8, characterised in that the resetting element is guided further downwards through the base plate or the grid.

10. The device according to claim 7, characterised in that the activation area is designed in the shape of a roof.

11. The device according to claim 7, characterised in that the activation area is designed as a cone shape.

12. The device according to claim 5, characterised in that the guide slot runs in the carrier sleeve in screw fashion.

13. The device according to claim 4, characterised in that the guide elements are designed as cylindrical.

14. The device according to claim 4, characterised in that the guide elements are spherical elements.

15. The device according to claim 4, characterised in that the guide elements are arranged in the area of the thickening.

16. The device according to claim 15, characterised in that the guide elements are provided so as to terminate with the base surface of the thickening.

17. The device according to claim 3, characterised in that the pin exhibits an elastic support surface extending out over its cover surface, and that the support surface is coated with anti-adherence material, for preference teflon.

18. The device according to claim 1, characterised in that the carrier element is designed in block fashion, with for preference a square cross-section.

19. The device according to claim 18, characterised in that the carrier element is connected to the base plate or the grid by means of screws or clip connection.

20. The device according to claim 19, characterised in that the connection is effected in the corner areas of the carrier element.

21. The device according to claim 1, characterised in that the positioning carriage comprises a setting device for setting the pins into their upper position.

22. The device according to claim 21, characterised in that the setting device is designed in the shape of a projection.

23. The device according to claim 22, characterised in that a setting device is allocated to each row of carrier elements running in the intake direction into the press area.

24. The device according to claim 1, characterised in that an activation device is provided for the activation of the resetting element.

25. The device according to claim 24, characterised in that a corresponding activator of the activation device is provided for each row of carrier elements.

26. The device according to claim 25, characterised in that the activator is cylindrical shaped and comprises a piston, which can be moved vertically in this cylinder, to activate the resetting element.

27. The device according to claim 26, characterised in that the piston carries a rotatably mounted roller or disk.

28. The device according to claim 25, characterised in that the piston is activated electromechanically, pneumatically, or mechanically.

29. The device according to claim 1, characterised in that the pin is provided with a cap, and that the pin and cap are connected by a connection element which is decoupled to prevent twisting.

30. The device according to claim 29, characterised in that the cap exhibits on its surface a slip-resistant, elastic element coated with an anti-adherent material.

31. The device according to claim 29, characterised in that the cap is roof-shaped in its side areas, broadening downwards.

32. The device according to claim 31, characterised in that the side areas of the cap broaden as far as the side length of the carrier element.
